(19) United States
(12) Patent Application Publication
(10) Pub. No.: US 2019/0236530 A1
(43) Pub. Date: Aug. 1, 2019

(54) PRODUCT INVENTORYING USING IMAGE DIFFERENCES

(71) Applicant: Walmart Apollo, LLC, Bentonville, AR (US)

(72) Inventors: Robert CANTRELL, Herndon, VA (US); Donald R. HIGH, Noel, MO (US); John J. O'BRIEN, Farmington, AR (US)

(73) Assignee: Walmart Apollo, LLC, Bentonville, AR (US)

(21) Appl. No.: 16/257,297

(22) Filed: Jan. 25, 2019

Related U.S. Application Data
(60) Provisional application No. 62/624,693, filed on Jan. 31, 2018.

(51) Int. Cl. G06Q 10/08; G06K 9/00; G06Q 20/20; G06T 3/40

(52) U.S. Cl. CPC G06Q 10/087; G06K 9/00369; G06T 3/4038; G06Q 20/203; G06K 9/00342

(57) ABSTRACT

A system and method for monitoring inventory of items includes a relatively lower resolution image device configured and arranged to capture a plurality of lower resolution images of a plurality of items on a shelf; and a relatively higher resolution image device configured and arranged to capture one or more higher resolution images of the plurality of items; and a computer system configured to: receive the plurality of lower resolution images; compare the plurality of lower resolution images to detect an image difference, the image difference corresponding to a moved item on the shelf; if an image difference is detected, process the image difference to focus on an area of the shelf where the image difference is detected; receive the one or more higher resolution images of the area of the shelf where the image difference is detected; and determine which item is missing or misplaced on the shelf.

### CROSS-REFERENCE TO RELATED APPLICATIONS

The present patent application claims priority benefit to U.S. Provisional Patent Application No. 62/624,693 filed on Jan. 31, 2018, the entire content of which is incorporated herein by reference.

### BACKGROUND

### 1. Technical Field

The present disclosure relates generally to inventory of items and more specifically to method and systems for inventorying items using differences in images of the items.

### 2. Introduction

Products or items for sale in retail stores are usually displayed on shelves or racks or provided inside containers, which themselves are displayed on shelves or racks. One source of store inefficiency is poor inventory management of items on shelves. One or more items in the inventory can be misplaced, miscounted, or may be missing undetected because of theft. This problem of poor inventory management of items on the shelves can be aggravated by the size of the store. The greater the size of the store, the greater the inventory of items and thus the greater the likelihood of having unaccounted for an item or items.

Present methods to account for misplaced, miscounted or missing items include visual inspection by a store associate of each shelf through the store and other areas of the store. However, this method is time consuming and requires a store associate to move isle by isle to locate misplaced or missing items.

Therefore, there is a need for a novel system and method to improve inventory accuracy and to better account for item inventory that is not where it should be. The systems and methods disclosed herein cure the above and other problems of existing methods and systems.

### SUMMARY

An aspect of the present disclosure is to provide a system for monitoring inventory of items. The system includes a relatively lower resolution image device configured and arranged to capture a plurality of lower resolution images of a plurality of items on a shelf, and a relatively higher resolution image device configured and arranged to capture one or more higher resolution images of the plurality of items on the shelf. The system further includes a computer system in communication with the relatively lower resolution image device and the relatively higher resolution image device, the computer system being configured to: 1) receive the plurality of lower resolution images from the lower resolution image device, 2) compare the plurality of lower resolution images to detect an image difference between the received plurality of lower resolution images, the image difference corresponding to a moved item on the shelf, 3) if an image difference is detected, process the image difference to focus on an area of the shelf where the image difference is detected, 4) receive the one or more higher resolution images of the area of the shelf where the image difference is detected, and 5) determine which item is missing or misplaced on the shelf.

Another aspect of the present disclosure is to provide method for monitoring inventory of items, the method being implemented on a computer system. The method includes receiving a plurality of lower resolution images from a lower resolution image device, the lower resolution image device being configured and arranged to capture the plurality of lower resolution images of a plurality of items on a shelf. The method further includes comparing the plurality of lower resolution images to detect an image difference between the received plurality of lower resolution images, the image difference corresponding to a moved item on the shelf. If an image difference is detected, the method includes processing the image difference to focus on an area of the shelf where the image difference is detected. The method also includes receiving one or more higher resolution images from a higher resolution image device of the area of the shelf where the image difference is detected, the relatively higher resolution image device being configured and arranged to capture the one or more higher resolution images of the plurality of items on the shelf; and determining which item in the plurality of items is moved, missing or misplaced on the shelf based on the one or more higher resolution images.

Additional features and benefits of the disclosure will be set forth in the description which follows, and in part will be obvious from the description, or can be learned by practice of the herein disclosed principles. The features and benefits of the disclosure can be realized and obtained by means of the instruments and combinations particularly pointed out in the appended claims. These and other features of the disclosure will become more fully apparent from the following description and appended claims, or can be learned by the practice of the principles set forth herein. It is to be expressly understood, however, that the drawings are for the purpose of illustration and description only and are not intended as a definition of the limits of the disclosure.

### BRIEF DESCRIPTION OF THE DRAWINGS

FIG. 1 depicts a diagram of a system for monitoring inventory of items on a shelf in a store, according to an embodiment of the present disclosure;

FIGS. 2A-2D depict schematically a location of an inventory item before and after movement of the inventory item, according to an embodiment of the present disclosure;

FIGS. 3A-3D show schematically an example of inventory in an autonomous inventory management system, according to an embodiment of the present disclosure; and

FIG. 4 is a flow chart of a method for inventorying items using differences in images of the items, according to an embodiment of the present disclosure.

### DETAILED DESCRIPTION

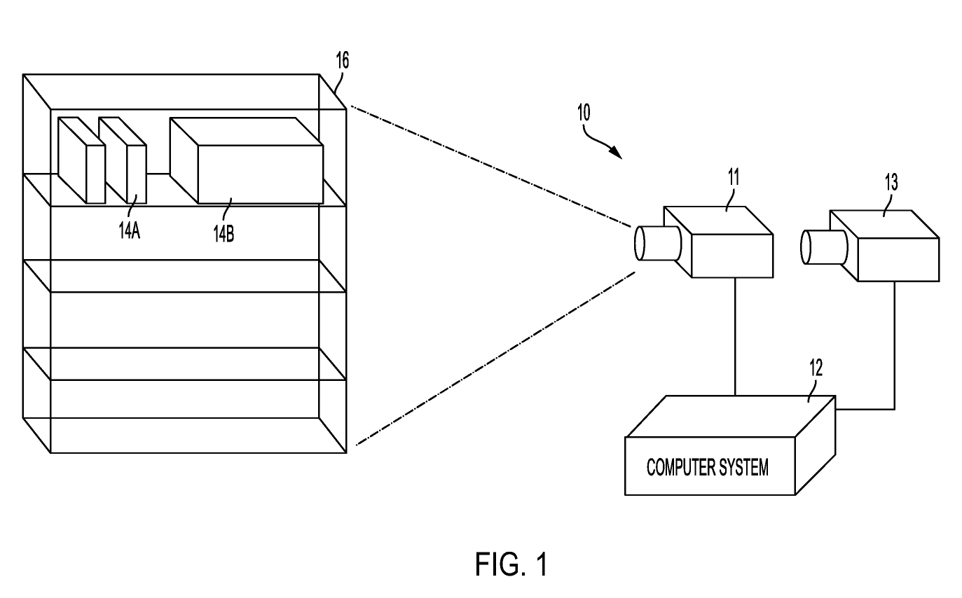

FIG. 1 depicts a diagram of a system 10 for monitoring inventory of items on a shelf in a store, according to an embodiment of the present disclosure. The system 10 for monitoring inventory includes an image device (e.g., a camera) 11 in communication with a computer system 12. In an embodiment, the computer system 12 may be configured to communicate with one or more databases (not shown) identifying the items carried by the store. The image device 11 is configured and arranged to take images of items 14A, 14B on shelf 16. In an embodiment, substantially an entirety of the shelf 16 is within a field of view of the imaging device 12. Although the items 14A, 14B are depicted in FIG. 1 being placed on a shelf 16, the items 14A, 14B can also be placed on racks, bins, or other holder of inventory, hanged or placed on the floor of the store. The items 14A, 14B can be any type of item that can be stored, inventoried or sold, including but not limited to, food, beverage, books, clothes, furniture, toys, sports equipment, etc. In an embodiment, the image device 11 can be configured to capture images of the items 14A, 14B on the shelf 16 periodically, for example, every few seconds or every few minutes to monitor item inventory. The image device 11 can be a still-image camera or a video camera, or a hyperspectral camera. The image device can be configured to capture image data in any desired wavelength range, including the infrared (IR), the visible (VIS), and ultraviolet (UV). The images captured by the image device 11 are downloaded to and received by the computer system 12 for processing. The computer system is configured to receive a plurality of images from the image device 11 and perform a comparison between the received images. Images are compared to detect differences between the images. When a difference in the images is detected, the difference is recorded indicating that there has been a change regarding the item(s) on the shelf, such as the item 14A, 14B is moved from the shelf.

Although one image device 11 is depicted in FIG. 1, a plurality of image devices 11 can also be used. For example, a relatively lower resolution camera (e.g., a High Definition “HD” Camera) can be used along with a higher resolution camera (e.g., a 4K or higher resolution camera) to capture images of the shelf 16. The lower resolution camera and/or the high resolution camera can be a still image camera or a video camera. The higher resolution camera can have a higher megapixel resolution (e.g., 8 Megapixels or higher). The image device 11 can capture images in any desired format including JPEG or MCS file or other format. The image device 11 can also be configured to capture a sequence of images as a video file (e.g., MPEG file format). The image device 11 can be static or mobile. For example, the image device 10 can be attached to the ceiling of the store or to an adjacent or opposite shelving system. The image device 11 can also be carried by a small vehicle on tracks attached to the ceiling of the store or to other structure in the store. Alternatively, the image device 11 can be attached to a drone or the automated vehicle or robot that can move through the isles in the store.

The image device 11 along with the computer system 12 can monitor inventory by detecting changes (deltas) in the images that indicate inventory has been handled or moved. The image device 11 along with the computer system 12 can supplement existing inventory management solutions that range from bar code, digital watermark, and RFID technologies used to identify inventory and its status from stocking to purchase, including basic manual observations from associates on the floor about inventory quantities and whether inventory is in the right place.

The image device 11 may not be employed to track all inventory of items as this would be challenging without direct visual line of site to every inventory item. Instead, the image device 11 along with the computer system 12 can track and monitor the changes in product inventory on shelves that indicate an inventoried item or product has been moved.

Movement of inventoried items is, of course, a desired end in a store. If the movement ends in a purchase of the items, and if all inventory movement went smoothly from truck to shelf to point-of-sale register then this movement tracking of items may not be needed. However, the movement of an item in a store may sometimes not result in the purchase of the item as the movement may be due to various reasons including: 1) the item is tried/examined but not purchased; 2) the item moved to view other products and not returned to its original display place; 3) the item is removed because the item is damaged; the item is handled and put back elsewhere than its intended place; 4) the item is pilfered.

The image device 11 may be able to capture a series of images and the computer system 12 may be able to process the images to determine through pixel and image analysis the differences in images that occur whenever a customer, a store associate, or other person, interacts with a shelf, rack, bin, or other holder of item inventory. Many off-the-shelf software programs are available for comparing images and detecting a difference (delta) in the images. The difference (delta) in pixels within images prior to interaction and after interaction indicates if an item inventory is moved or removed. Processing of the images by the computer system 12 can focus on the area of the images exhibiting a pixel difference while ignoring areas of the images that does not exhibit any or exhibit minimal pixel difference, thus saving processor time and making the data more manageable. Other mechanisms may also be used to determine when there has been interaction with an item/shelf, and the images before and after the interaction are compared.

In an embodiment, the system 10 may use a motion detector to determine when shelf 16 is clear of human activity or it may also use images of the shelf 16 with customer(s) partially obscuring items 14A, 14B and stitch together an image of the shelf 16 as customer(s) move in and out of the frame. In an embodiment, the image device 11 can be a relatively lower resolution camera such an HD camera that can be configured to capture images in lower resolution (such as lower pixel resolution black and white images or lower pixel resolution color images). The image device 11 can be used to scan the shelf 16 to identify areas of the shelf where a difference or delta in a sequence of images is detected. The system 11 may further include a higher resolution camera 13, such as a 4K or higher resolution camera, or a still camera with a higher megapixel resolution configured to take images with a higher pixel resolution (e.g., 8 Megapixels or higher), to focus on the areas of the shelf 16 where an image delta is detected or found and determine which products are out of stock, missing or misplaced. Focusing on the area of the shelf 16 where an image delta is detected can be accomplished by using the camera's optical zoom or by using the camera's digital zoom or by digitally zooming the captured image where a delta is detected.

In an embodiment, the system 10 can be configured to take a baseline image of shelf 16, for example after the shelf 16 is fully stocked. For example, this can be accomplished by using a store associate's mobile device, device location and item scans which the associate normally completes while stocking shelves. Alternatively or in addition, the system 10 can use camera 11 or camera 13 or both to take a baseline picture of the shelf 16 when the shelf 16 is fully stocked or at other times. The system 10 can store the baseline picture in the computer system 12 for further reference. The baseline picture may be associated with an identifier indicating a location(s) shown in the image, and stored in a database. The system 10 can further use the image device 11 or image device 13 or both to identify an associate by photographing the store associate's work identification badge.

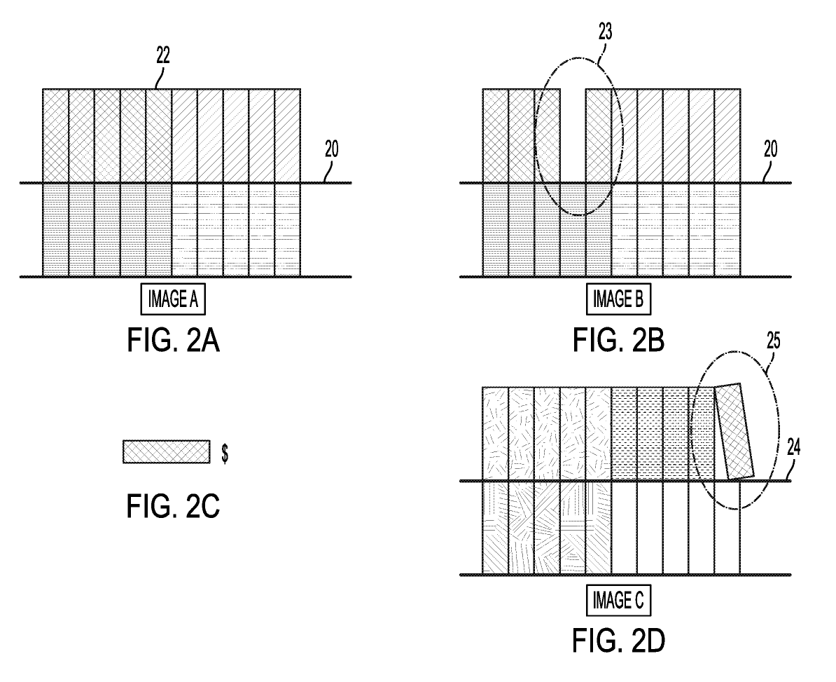

FIGS. 2A-2D depict schematically a location of an inventory item before and after movement of the inventory item, according to an embodiment of the present disclosure. For example, if a shelf 20 stores a plurality of items (for example 5 items) 22, and a customer interacted with items 22 on shelf 20, and if the image device 11 captures a sequence of images (including Image A of the shelf 20 and Image B of the shelf 20) and an image difference 23 between the images (Image A and Image B) is detected by the computer system 12 (shown in FIG. 1), the image difference 23 between the two images (Image A and Image B) may have been generated by a customer putting one of the items 22 into his cart. In an embodiment, the system 10 can be configured, for example by programming the computer system 12 to detect and to allow for small changes in item placement (e.g., a tolerance of about half of an inch left or right of its original position) without flagging such a change as being an image difference or a delta. The image difference 23 between Image A and Image B can be logged by the computer system 12 as a probable impending purchase. The purchase may be confirmed when a transaction occurs. The purchase is confirmed, when the register detects the scanned bar code associated with the moved item, as depicted schematically in FIG. 2C. The computer system 12 will reconcile image changes with purchases and then decrease the inventory of items 22 (initially equal to five in this example) by one item and record that the inventory has changed from five items 22 to four items 22. Since the image difference detected by the computer system 12 has a corresponding purchase that fits with the image change, the system may determine that no anomaly in the inventory has taken place due to the interaction of the customer with the shelf 20.

In another scenario, a customer may handle one of the plurality (for example five) of items 22 and perhaps may even put the item into a shopping cart. Perhaps several aisles later, the customer changes their mind about the purchase of one of the items 22 and simply leaves the item behind on another shelf 24, or even returns it to the original shelf 20 but does not quite put it back in the right place, as shown in FIG. 2D. This may create an anomaly in the inventory as the picked up item did not end at the point of sale scanned and purchased, as illustrated in FIG. 2C. Some of these anomalies take care of themselves either because a store associate notices the misplaced item and corrects it, or another customer may find the misplaced item and buy it by happenstance.

However, other items may stay lost in the wrong place for a long period of time. In a large store (e.g., a superstore such as Walmart) the number of these misplaced items can add up to a lot of lost inventory that perpetually occupies space. Because most misplaced inventory is, at least in the beginning, visible when misplaced, the image difference based system 10 can detect the misplaced inventory item before it becomes truly lost or notices the item on another shelf.

If an item 22 is removed from shelf 20, the system 10 expects a purchase to take place of that item 22. If the purchase of the item 22 does not take place after a certain period of time, the system 10 can be configured or programmed to search through other image differences recorded on other images during the time period, focusing on image differences where an item is added or where an item emerges. For example, FIG. 2D shows an image C of shelf 24 where an item 25 is added to shelf 24 or item 25 emerges compared to a previously captured image. This will narrow down the search by the computer system 12 to instances where an item is added to a shelf instead of performing a search among all image differences detected. In addition, by further prioritizing on image differences (deltas) where the added item 25 best fits the item 22 that was removed or moved, the processing time or search time by the computer system 12 can be decreased. For example, if the item removed was packaged inside a red box, an image difference (delta) that showed the addition of a red box elsewhere would offer an action to investigate, whereupon the misplaced inventory item may be retrieved. For example, if the red box item is detected being added or emerges at 25 on shelf 24, the computer system 12 can provide the location of the shelf 24 where the misplaced red box item 25 is located to the store associate. This will allow the store associate to locate and retrieve the red box item 25 within a shorter period of time instead of searching throughout the store for the red box item. In an embodiment, this technique may supplement other detection technologies, such as RFID sensors, laser-based scanners, or weight-based sensors, with the benefit that the image difference based detection can narrow an inventory search quickly to a particular area. In another embodiment, this may further trigger the use of a higher resolution image device to further investigate in order to locate the red box item.

In an embodiment, various procedures can be provided for situations wherein an image of a shelf is not available. For example, image devices 11 (e.g., cameras) are not allowed in dressing rooms. A large number of moved inventory items end up in dressing rooms where prospective customers leave the items after trying them. In the process of using image difference based detection to track inventory anomalies, store associates monitor camera-free zones by returning abandoned inventory items to a return shelf or return rack. Each inventory item when returned to a return shelf or rack will create a new image difference. For example, on one hand, when an item is moved from a display shelf or rack containing for example five items by a prospective customer, the five items decreasing to four items can be detected by the image device (e.g., camera) 11 and recorded by the computer system 12 as a first delta or a first image different. In this case, the first delta is “a negative delta” as the number of items decreased from 5 items to 4 items on the shelf. On the other hand, an item retrieved from a dressing room and returned to its proper shelf is also detected by an image device 11 and recorded by the computer 12 as a second delta or a second image difference. In this case, the second delta is “a positive delta” as the number of items increased on the shelf. However, because the returned product is returned to its intended place on the proper shelf by the store associate, the returned item would fit the profile of the once moved item. As a result, the second delta (negative delta) will cancel out the first delta (positive delta) because the item is now recorded as being located where it is actually supposed to be, satisfying the monitoring and inventorying needs of the store.

In an embodiment, the system for monitoring inventory can be further configured to detect some image differences or deltas that require no further action. A lower resolution image may be used for an initial image comparison. The system may identify situations where further action is required, such as higher resolution images and comparison or a visit by a store associate. For example, if the five items are still on the shelf but the five items on the shelf are simply moved, then in this case the system does not trigger an event that needs to be managed. If, for example, five items on the shelf appear to become four when a customer moved an item by pushing the item behind the other items so that the moved item is out of view of the imaging device 11, the process for finding moved inventory items may involve an associate, robot, or drone (UAV) going to the shelf to check whether the item has been moved from line of sight. This action of checking and correcting the position of the moved item can benefit sales because a hidden item is less likely to be purchased than a visible item.

Depending on sensitivity and programming of the system 10 for monitoring inventory, added benefits may also be provided. For example, if a customer reaches into a stock for an item in a back row of a shelf or nearer the back row, the system 10 may be able to detect that an item is in hand of the customer and initially record a probable purchase or flag the item as a potential purchase. If the probable purchase does not occur after a certain elapsed period of time, the system 10 can flag a potential inventory anomaly. The system 10 then starts searching for the item elsewhere, and flag that a store associate or robot may need to recount the items in that stock when other items of different types need not be counted. The image device 11 of the system 10 may also be aimed at a register to detect items removed from a shelf but are not purchased. For example, the items may instead be stolen either at the site of the shelf or that an item fitting the profile of the item moved or removed has gone through the register area without having been logged as a purchase. This may occur, for example, when the barcode scanned is associated with an item purchased and paid for that is different from the item missing from the shelf while the item missing from the shelf is stolen and put into a bag.

In an embodiment, an optical scanning technology can be used to aid the process of accounting for the inventory. In an analogy, a farmer may know how many cows, pigs, and chickens the farmer owns and wants to know that they are in their respective pens, but does not give importance to their respective location in those given pens. The optical system is used to detect exceptions, having a system that is refined enough to point out where management may need to take a closer look at a given shelf. For example, the system 10 may know that the two pound box of TIDE detergent should be on a certain shelf, and as long as orange boxes of proportional size are located on that shelf, it does not flag a problem. However, if something is off, for example a different shaped box, different color box, wrong bar code if visible, the system 10 can flag the shelf to be checked by an associate or a specialist robot.

In an embodiment, the system 10 can also be configured to identify each item container independently so that if the container moves slightly, the system 10 is able to recognize the item. This can be performed using a higher resolution camera 13 (depicted in FIG. 1), for example. The system 10 can also be configured to “read” or recognize shelf labels associated with each item, count a number of item faces on the shelf and compare the number to what the a label associated with the item indicates. The system 10 can also be configured to check whether all labels are on the shelves and in a correct order or in accordance to a planogram.

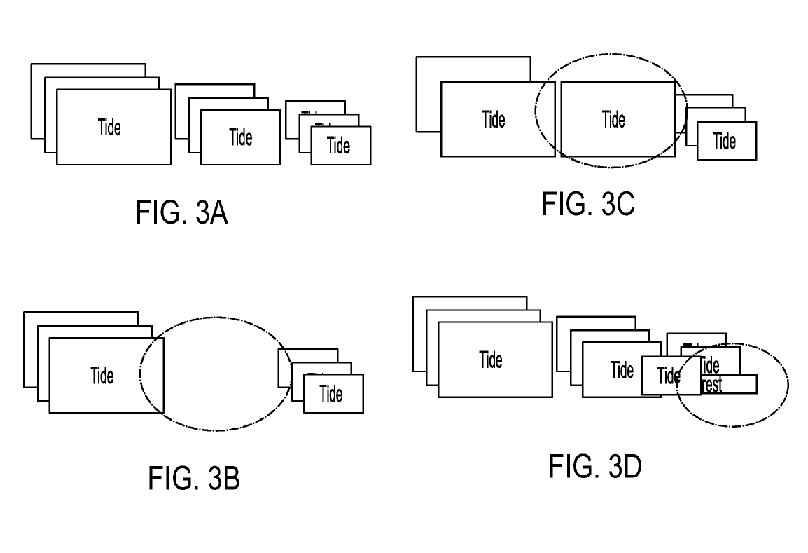

One goal of using the system 10 is to allow autonomous inventory management to work in tandem with a seller's common sense. FIGS. 3A-3D show schematically an example of inventory in an autonomous inventory management system, according to an embodiment of the present disclosure. For example, assuming there are three sizes of TIDE detergent, as shown in FIG. 3A, if an image that fits the item profile that is supposed to be at a location, the system 10 assumes that the inventory is in its proper place. If, for example, a certain size of TIDE detergent has run out (for example the medium size has run out), as illustrated in FIG. 3B, rather than leave the spot empty, and therefore losing money, it makes sense to spread out the other two sizes of detergent of the same brand TIDE so that the whole shelf is covered and the stock looks good, as shown in FIG. 3C. However, the system 10 will flag on its surveys that the wrong product is in the slot where the missing size (in this example the medium size) should be. Until restocked, a manager would leave the shelf as is, as shown in FIG. 3C, but once new inventory arrives, the flag will serve as a reminder to put the shelf back to where it handles all three sizes, as shown in FIG. 3A. In this instance, once the inventory is replenished with the missing size (in this case the medium size) TIDE detergent, the inventory will self-correct as the system 10 will capture the change back from the configuration shown in FIG. 3B to the original configuration shown in FIG. 3A.

The primary goal in this scenario is still to focus on the exceptions where something, a shape, color, size, weight, tag indicates that something may be out of place, even if it cannot be identified specifically, so that a store associate or autonomous systems or robots can check the reason behind those exceptions and correct as needed. For example, if an item does not fit the profile of an item that is supposed to be at a certain location, as shown in FIG. 3D, the system flags this situation as an anomaly.

Embodiments of the present system and method of monitoring inventory has many benefits and improvements including:
1. Removing unnecessary action: Eliminating the need to inventory all items by inventorying only those items where imaging has detected a delta that shows an item is missing or moved yet not purchased or logged as damaged and removed.
2. Breaking a link in the chain: Reducing the possibility that inventory can be lost by detecting early image deltas that show inventory item has been moved and finding the inventory item while the item is still likely to be visible on other image deltas.
3. Placing objects safely apart: Providing dividers on shelves or other separators that reduce the likelihood that products will be jiggered and hidden by each other.
4. Separating incompatible objects: In addition to detecting image deltas, software in system 10 may further detect anomalous lacks of uniformity, for example, that in a bin of red and white Campbell Soup cans is a green can that is peas.
5. Doing enough but not all: The system 10 itself is not required to detect specifically what products are, but instead its main role is to quickly and continuously detect the deltas that can be investigated by people or by robots optimized for identification.
6. Removing harmful parts: Optimizing the store for camera visibility that not only helps the image-delta cameras, but helps shoppers find what they are looking for.
7. Making the acquired images disposable: Keeping the captured images for a period of time but not necessarily permanently.
8. Filling multiple roles: The image devices (e.g., cameras) used to record footage for image deltas can also be used as security cameras and image-deltas can also be used to help security identify where shoplifting may have occurred and by whom.
9. Making the system visible or invisible to the customer: Performing social check to see whether the store benefits more from having visible cameras to deter shoplifting or invisible cameras so desired customers do not feel uncomfortable
10. Leveraging unexpected benefits: Given ample resolution of the image devices 11 (e.g., cameras), the system 10 may become the basis of an AMAZON GO type purchasing system (with no checkout).
11. Leveraging further unexpected benefits: If the system 10 logs an item as likely put into a cart and the item is not actually purchased, the customer may be flagged in a otherwise random product security checks to determine if the missing item is in their possession.
12. Increasing user friendliness: The image delta processing takes place in real time, particularly with deltas that show an item has appeared where it was not before, so that associates or robots can check for the missing or misplaced item sooner rather than later.
13. Focusing resources and actions: Focusing Inventory actions on places of image deltas rather than the entire superstore
14. Intentionally exceeding requirement: Installing high-resolution cameras that can be configured to detect other useful elements, such as bar codes or to OCR labels so that the high-resolution camera can be employed for further benefits with the appropriate software.
15. Optimizing parts for their tasks: Putting the system 10 into a broader inventory system of robots and people where each performs its intended task, with the cameras tracking where to look and other elements doing the actual looking.
16. Compensating for unreliability: The system 10 allows one element to address the weakness of another, for example, the image-delta system 10 may easily detect that something is different but not what is different, and an associate can easily detect the what but not that there was a difference he should attend to.
17. Isolating a part from the whole: Optimizing product placement with contrasts that make it easier to detect anomalies, with the residual benefit that it makes shopping easier on the customer. For example, putting the blue box of cereal next to an orange box rather than another blue box.
18. Hiding the vulnerable: Leveraging image delta monitoring as a way to put fewer of a given item on a shelf that will have the combined benefit of: 1) making it easier to monitor the number of a given items on the floor; 2) allowing fewer of a given item to be on the floor since they could be rapidly replaced from the stock room; 3) allowing more variety of products in total to be carried, and more efficiently since camera image deltas make it easier to track inventory, a positive cascade.
19. Restoring while in use: Any change recorded as a delta immediately sets a new image from which new deltas will be detected.
20. Using reverse actions: Associates stocking shelves can “scan” shelved products by properly presenting items to associated cameras monitoring those shelves rather than using a separate scanner. The camera could signal, perhaps through a light or onto a smart device or tablet, that the item has been logged as placed or removed from the shelf.
21. Doing the opposite of the expected: Data analysts review imaging for places where few deltas have taken place to understand why given products are not being moved, and therefore purchased, be it an issue with the product or an issue with store layout.
22. Moving the other object: Although tying movement to specific individuals may be lost, an Automatic Guided Vehicle (AGV), an Unmanned Aerial Vehicle (UAV) (drone), or rail camera monitoring system can be used where image deltas are measured after each given pass of the camera versus continually from fixed cameras. Such system can save on installation costs and make it easier and less expensive to upgrade cameras and equipment, and such system may be good enough to get most of the desired inventory management benefits.
23. Viewing from the other side: Cameras may capture images from the shelves so that the camera are viewing and monitoring the items in the hand of the customer, including whether the customer takes an item in hand and puts it back where it is not supposed to be.
24. Using two wrongs to make a right: Image deltas where products are missing are paired with image deltas where like products appear as probable sources of anomalies.
25. Repeating until successful: Analyzing image deltas that may answer an anomaly until the reason is found or until all associated deltas have been analyzed.
26. Executing tasks in parallel: reviewing many image deltas at substantially the same time or in parallel and registering for what they are. For example, an item that appears at a wrong place becomes an anomaly to check that can be one of many anomalies.
27. Gaining strength in numbers: Leveraging the power of computers that can handle image stitching in ways beyond 360 views where the computer can, in a sense, see the entire store at once whereas people need to review one section at a time. The stitched image of the product or its container can be watched from pickup to placement on a continual, never-broken track.
28. Recreating the past: Anomalies can initiate a review of the entire track, and product may be located by that track.
29. Inserting an assisting element: Even a very small element, a chip, a metal, etc., may be attached visibly to each product to make it easier to detect by cameras set to detect image deltas, for example, a reflector like the eyes of a catfish that glow with an infrared flash unseen by people.
30. Obtaining best of both systems: The system 10 can supplement, but does not necessarily replace, existing inventory systems (unless truly made redundant).
31. Changing the color: Image deltas are made easy to view by use of different colors, with color coding attached to inventory anomalies such as newly missing, newly present, item to check, or other such signals can be useful.
32. Allowing both flexibility and rigidity: The system 10 can handle even small image deltas, such as shifting of five items on a shelf, when there are clearly still five items on the shelf though they have been moved slightly.
33. Allowing partial mobility: Image deltas can be geo-fenced to monitor items in the zone more so than in specific spots.
34. Using hot or cold: Infrared capable cameras can help target where or how item anomalies take place by focusing the deltas on inventory that has a heat signature indicating that it has been handled by a person.
35. Providing for self-service: The system 10 can incorporate autonomous robots throughout to detect, track, and correct anomalies.
36. Adapting based on feedback: Recording where the system 10 is correct in its determination and where it is incorrect in its determination in order to improve success by using machine-learning algorithms.
37. Using outflow indicators: Determining how items are able to disappear (shrinkage) undetected using the given process.
38. Using both sides: Monitoring stock rooms under policies that benefit from how inventory should stay in place with no deltas unless a specific and assignable or logged event takes place. The system can be configured to eliminate the large percentage of shrinkage that may take place in the stock rooms.

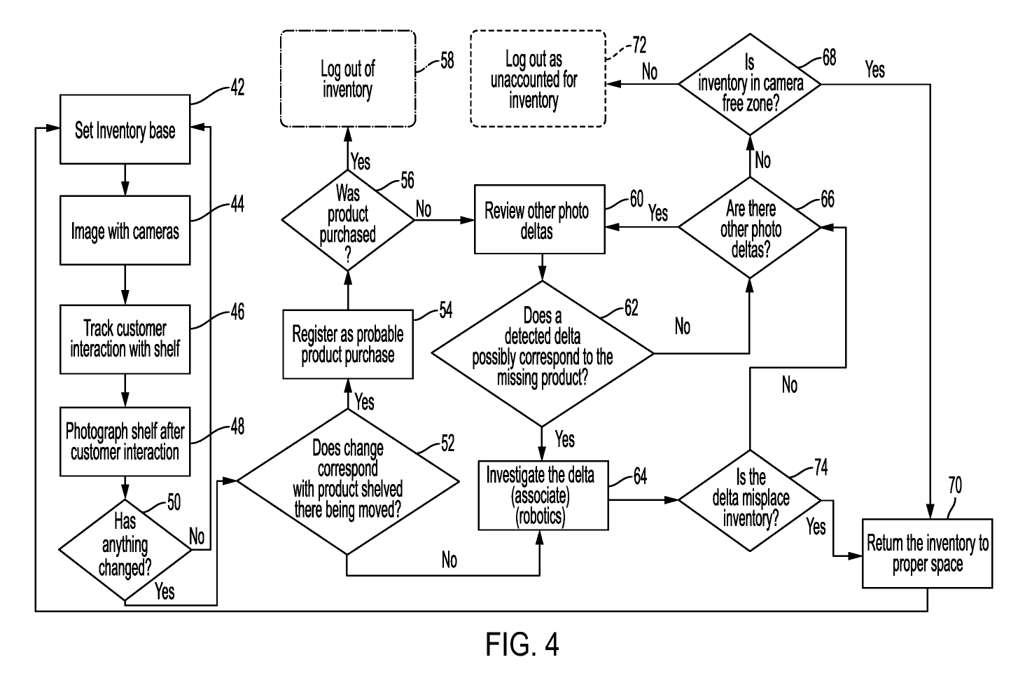

FIG. 4 is a flow chart of a method for inventorying products using differences in images of the items, according to an embodiment of the present disclosure. Initially, an inventory database of all items carried by the store is set, at step 42. The inventory of all items can be stored in a database which may be linked to computer system 12. In the process of checking for the inventory of items in the store, images of the items on the shelf 16 are taken by the image devices 11, 13, at step 44. In an embodiment, the interaction of the customer with the shelf 16 is tracked using the image device 11, 13, at step 46. An image of the shelf 16 is captured after the interaction of the customer with the shelf 16, at step 48. The computer system 12 compares a first image captured by the image device 11, 13 before interaction of the customer with the shelf 16 and a second image captured by the image device 11, 13 after interaction of the customer with the shelf 16. The computer system 12 performs a test to check whether anything on the shelf 16 changed, at step 50. If nothing changed (i.e., “no”) the system loops back to the inventory step, at step 42.

If, the computer system 12 detects that something changed on the shelf (i.e., “yes”), the computer system 12 performs another test to check whether the change on the shelf 16 corresponds to a movement of an item on the shelf, at step 52. The system may identify the item, for example by reading a SKU, or other identifier or verifying characteristics of the item. If the computer system 12 determines that the change detected corresponds in fact to an item being moved on the shelf 16 (i.e., “yes”), at step 52, the computer system 12 registers the difference between the images as a probable product purchase, at step 54.

The computer system 12 then checks whether the item detected as being moved on the shelf is purchased, at step 56. If the item is detected as being purchased via the point of sale system or register system (i.e., “yes”), at step 56, the item is removed from the inventory database and logged out of the inventory, at step 58. If the item is not detected as purchased at the point of sale or register (i.e., “no”), at step 56, the second image taken by the image device 11, 13 is reviewed for other types of deltas or image differences, at step 60.

The computer system 12 then performs another test to determine whether the detected image delta possibly corresponds to the item missing, at step 62. The test may include comparing characteristics of the item, such as size, color, etc., comparing item identifiers, and the like. If the computer system 12 determines that the item is missing (i.e., “yes”), at step 62, the computer system 12 will prompt a store associate or command robotic systems to further investigate where/why the item is missing, at step 64.

If the computer system 12 determines that the change detected does not correspond to an item being moved on the shelf 16 (i.e., “no”), at step 52, the computer system 12 will also prompt a store associate or command robotic systems to further investigate where/why the item is missing, at step 64.

If the computer system 12 determines that the item is not missing (i.e., “no”), at step 62, the computer 12 performs another test to determine whether there are other image deltas or image differences detected by other image devices in the store and stored by the computer system 12, at step 66. If the computer system 12 determines that there are other image deltas (i.e., “yes”), at step 66, the computer system then reviews other images deltas, at 60. If the computer system 12 determines that there are no other image deltas (i.e., “no”), at step 66, the computer system then performs a test whether the inventory is in an image device (e.g., camera) free zone, at step 68. If the computer system 12 determines that the inventory is in an image device (e.g., camera) free zone (i.e., “yes”), at step 68, the computer system 12 can flag the item to a store associate to return the item to its proper display location, at step 70. If the computer system 12 determines that the inventory is not in a camera free zone (i.e., “no”), at step 68, the computer system 12 can log out the item as unaccounted for inventory, at step 72.

If the computer system 12 determines that the item is missing (i.e., “yes”), at step 62, this will prompt a store associate or using robotics to further investigate where/why the item is missing, at step 64. The computer system 10 can then check whether an image delta detected elsewhere corresponds to misplaced item inventory, at step 74. If the computer system 12 determines that the misplaced item corresponds to an image delta detected elsewhere by another camera for example (i.e., “yes”), at step 74, the computer system 12 can flag the item to a store associate to return the item to its proper display space, at step 70. If the computer system 12 determines that the misplaced item does not correspond to an image delta detected elsewhere by another camera for example (i.e., “no”), at step 74, the computer system 12 perform the test again at step 66.

In the above paragraphs, the processing or comparison between the images is described as being performed by the computer system 12. However, in another embodiment, the image device 11 or image device 13 may also be configured or programmed internally to perform the image comparison in situ. In this case, the computer system 12 receives the image difference directly from the image device 11 and further comparison may not be needed. In which case, the computer system 12 can be configured to perform other processing tasks such as keeping track of the received delta images or cataloguing the delta images.

The term “computer system” is used herein to encompass any data processing system or processing unit or units. The computer system may include one or more processors or processing units. The computer system can also be a distributed computing system. The computer system may include, for example, a desktop computer, a laptop computer, a mobile computing device such as a PDA, a tablet, a smartphone, etc. A computer program product or products may be run on the computer system to accomplish the functions or operations described in the above paragraphs. The computer program product includes a computer readable medium or storage medium or media having instructions stored thereon used to program the computer system to perform the functions or operations described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card (e.g., a USB flash card), PCMCIA memory card, smart card, or other media. Alternatively, a portion or the whole computer program product can be downloaded from a remote computer or server via a network such as the internet, an ATM network, a wide area network (WAN) or a local area network.

Stored on one or more of the computer readable media, the program may include software for controlling both the hardware of a general purpose or specialized computer system or processor. The software also enables the computer system or processor to interact with a user via output devices such as a graphical user interface, head mounted display (HMD), etc. The software may also include, but is not limited to, device drivers, operating systems and user applications. Alternatively, instead or in addition to implementing the methods described above as computer program product(s) (e.g., as software products) embodied in a computer, the method described above can be implemented as hardware in which, for example, an application specific integrated circuit (ASIC) or graphics processing unit or units (GPU) can be designed to implement the method or methods, functions or operations of the present disclosure.

Various databases can be used and may include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Standard Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Although the embodiments of disclosure have been described in detail for the purpose of illustration based on what is currently considered to be the most practical, it is to be understood that such detail is solely for that purpose and that the present disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed:

1. A system for monitoring inventory of items, comprising:
a relatively lower resolution image device configured and arranged to capture a plurality of lower resolution images of a plurality of items on a location;
a relatively higher resolution image device, compared to the lower resolution image device, configured and arranged to capture one or more higher resolution images of the plurality of items at the location; and
a computer system in communication with the relatively lower resolution image device and the relatively higher resolution image device, the computer system being configured to:
receive the plurality of lower resolution images from the lower resolution image device,
compare the plurality of lower resolution images to detect an image difference between the received plurality of lower resolution images, the image difference corresponding to a moved item at the location,
if an image difference is detected, process the image difference to focus on an area of the location where the image difference is detected,
receive the one or more higher resolution images of the area of the location where the image difference is detected, and
determine which item is missing or misplaced at the location.

2. The system according to claim 1, wherein the relatively lower resolution image device is a high definition (HD) camera or lower resolution.

3. The system according to claim 1, wherein the relatively higher resolution image device is a 4K camera or higher resolution.

4. The system according to claim 1, further comprising a motion detector in communication with the computer system and configured to determine when the location is clear of human activity to activate the lower resolution image device.

5. The system according to claim 1, wherein the lower resolution image device is configured to stitch the plurality of images together wherein a customer moves in and out of frame to generate an image of the location free from the customer.

6. The system according to claim 1, wherein the computer system is further configured to receive a baseline image of the location when the location is fully stocked with items.

7. The system according to claim 1, wherein, if the image difference is detected, the computer system is further configured to log the image difference corresponding to a moved item at the location as an impending purchase.

8. The system according to claim 7, wherein the computer system is further configured to receive information from a register and determine when the register detects that an item is sold.

9. The system according to claim 8, wherein the computer system is further configured to compare the item sold with the image difference logged as an impending purchase and if the image difference corresponds to the item sold, the computer system is configured to remove the item from an inventory database and does not record an anomaly.

10. The system according to claim 8, wherein the computer system is further configured to compare the item sold with the image difference logged as an impending purchase and if the image difference does not correspond to the item sold, the computer system is further configured to search through other detected image differences.

11. The system according to claim 10, wherein the computer system is configured to search through other detected image differences focusing on image differences where an item appears to be added to a location.

12. The system according to claim 10, wherein the computer system is configured to search through other detected image differences focusing on image differences where an item appears to have a similar shape, a similar color, a similar logo, or a similar picture, or any combination thereof.

13. The system according to claim 10, wherein the computer system is further configured to search through other detected image differences and if the computer system locates an image difference among the other detected image differences that corresponds to the image difference corresponding to the moved item at the location, the computer system is configured to flag the moved item as being located and indicate to a store associate a location of the moved item.

14. The system according to claim 1, wherein the computer is configured to receive the one or more higher resolution images of the area of the location where the image difference corresponding to a moved item at the location is detected to identify the moved item.

15. The system according to claim 1, wherein the computer system is configured to identify the moved item by controlling the higher resolution image device to read or recognize a location label associated with the moved item.

16. The system according to claim 15, wherein the computer system is configured to identify the moved item by controlling the higher resolution image device to count a number of items at the location and compare with a number of items indicated at the location label associated with the item.

17. The system according to claim 1, wherein the computer system is configured to check whether all labels associated with items are on the shelves and in a correct order or are disposed in accordance to a planogram by controlling the higher resolution image device to stare at the labels.

18. The system according to claim 1, wherein the relatively higher resolution image device is a still camera having a megapixel resolution higher than 8 megapixels.

19. The system according to claim 1, wherein the relatively higher resolution image device is configured to digitally zoom on the area of the location where the image difference is detected.

20. A method for monitoring inventory of items, the method being implemented on a computer system, the method comprising:
receiving a plurality of lower resolution images from a lower resolution image device, the lower resolution image device being configured and arranged to capture the plurality of lower resolution images of a plurality of items on a shelf;
comparing the plurality of lower resolution images to detect an image difference between the received plurality of lower resolution images, the image difference corresponding to a moved item on the shelf;
if an image difference is detected, processing the image difference to focus on an area of the shelf where the image difference is detected;
receiving one or more higher resolution images from a higher resolution image device of the area of the shelf where the image difference is detected, the relatively higher resolution image device being configured and arranged to capture the one or more higher resolution images of the plurality of items on the shelf; and
determining which item in the plurality of items is moved, missing or misplaced on the shelf based on the one or more higher resolution images.
